(19) United States
(12) Patent Application Publication
(10) Pub. No.: US 2020/0371675 A1
(43) Pub. Date: Nov. 26, 2020

(54) METHOD AND APPARATUS FOR CONTROLLING PLAYBACK TIME POINT OF MEDIA CONTENT

(71) Applicant: INTELLECTUAL DISCOVERY CO., LTD., Seoul (KR)

(72) Inventor: Si Kyong SUNG, Sejong-si (KR)

(73) Assignee: INTELLECTUAL DISCOVERY CO., LTD., Seoul (KR)

(21) Appl. No.: 16/955,466

(22) PCT Filed: Dec. 18, 2018
(86) PCT No.: PCT/KR2018/016095

§ 371 Date: Jun. 18, 2020

(30) Foreign Application Priority Data
Dec. 19, 2017 (KR) 10-2017-0175366

(51) Int. Cl. G06F 3/0484; G06F 3/0488; G06F 3/0485; G11B 27/00

(52) U.S. Cl. CPC G06F 3/04845; G11B 27/005; G06F 3/04855; G06F 3/0488

(57) ABSTRACT

A media content playback apparatus according to an embodiment can change the playback time point of a media content on the basis of the movement of a user's finger or a mouse pointer for dragging on a display. The media content playback apparatus can determine the movement distance of the finger or the mouse pointer on an axis parallel to a main search bar and a time scale which is the rate of change of a playback time point, on the basis of the start point of the user's dragging on the display. The playback time point can be changed on the basis of the determined time scale and the determined movement distance of the finger or the mouse pointer on the axis parallel to the main search bar.

### TECHNICAL FIELD

Example embodiments relate to a media content playback apparatus and a method performed by the media content playback apparatus.

### BACKGROUND ART

A media content playback apparatus may provide a user with a control function, allowing the user to control the playback of a media content including audio data and/or video data based on a time of the media content. The control function of the media content playback apparatus may include, for example, a play function, a pause function, a forward seek function, a reverse seek function, a skip forward function, and a skip back function. These functions may be provided in a form of a linear search bar that is positioned mainly at an upper end, a lower end, an upper boundary, or a lower boundary of a display. A slider that moves along the linear search bar may provide a visual representation of a playback time point of a media content that is being played, and allow the user to change the playback time point by moving the slider along the linear search bar in both directions.

A user may drag an indicator in the search bar in a direction of the search bar to move a playback time point of a media content. In such a case, the user may rapidly explore a desired playback time point of the media content by adjusting a timescale that adjusts the playback time point. However, according to related arts, such a timescale may be adjusted only on a separate screen provided for setting the media content playback apparatus, or a plurality of drags including a vertical drag may need to be performed to adjust the timescale. According to such related arts, a user may need to perform a plurality of operations or manipulations to adjust a timescale, and thus a great amount of time may be required to move a playback time point of a media content. Thus, it may not be possible to provide an increased level of convenience and intuitiveness to users who desire to rapidly explore a playback time point of a media content.

### DISCLOSURE OF INVENTION

### Technical Goals

An aspect provides a media content playback apparatus and a media content playback controlling method that may allow a user to precisely explore a playback time point of a media content with a least operation or manipulation.

### Technical Solutions

According to an example embodiment, there is provided a media content playback controlling method of a media content playback apparatus. The media content playback controlling method includes receiving, as an input, a drag on a display of the media content playback apparatus, and moving a playback time point of a media content by a movement time corresponding to a length of the drag. The movement time may be determined based on a timescale determined by a start point of the drag.

The timescale determined by the start point of the drag may be maintained during the progression of a path of the drag.

The timescale may be determined by a distance by which the start point of the drag is separated from a reference line of the display.

The reference line may be a main search bar displayed on the display or an outer line of the display.

The media content playback controlling method may further include displaying, on the display, a sub-search bar based on the timescale.

The media content playback controlling method may further include displaying the main search bar for exploring a full time interval of the media content. The sub-search bar may correspond to a portion of the full time interval corresponding to the timescale.

The media content playback controlling method may further include displaying an image of a plurality of playback time points included in the portion of the full time interval, among images included in the media content, in response to the sub-search bar.

The media content playback controlling method may further include displaying, on the display, information associated with the determined timescale.

The length of the drag may be a distance by which the path of the drag moves along a preset axis on the display.

According to another example embodiment, there is provided a media content playback apparatus configured to play a media content. The media content playback apparatus includes a controller configured to control playback of the media content, and a display configured to display a playback screen corresponding to a playback time point of the media content. The controller may be configured to move the playback time point of the media content by a movement time corresponding to a length of a drag input on the display based on a timescale corresponding to a start point of the drag.

The timescale determined by the start point of the drag may be maintained during progression of a path of the drag.

The controller may be configured to determine the timescale based on a distance by which the start point of the drag is separated from a reference line of the display.

The reference line may be a main search bar displayed on the display or an outer line of the display.

The display may be configured to display a sub-search bar based on the timescale.

The display may be configured to display the main search bar for exploring a full time interval of the media content. The sub-search bar may be configured to display a portion of the full time interval corresponding to the timescale.

The display may be configured to display an image of a plurality of playback time points included in the portion of the full time interval among images included in the media content, in response to the sub-search bar.

The display may be configured to display information associated with the timescale.

The length of the drag may be a distance by which the path of the drag moves along a preset axis on the display.

According to still another example embodiment, there is provided a media content playback controlling method of a media content playback apparatus. The media content playback controlling method includes receiving, from a user, an input that forms a drag path, determining at least one timescale based on the drag path, and moving a playback time point of a media content based on the timescale and the drag path. One of the at least one timescale may be determined based on a start point of the drag path.

The at least one timescale may be determined respectively for a plurality of sub-paths forming the drag path based on a start point of each of the sub-paths.

The moving may include moving the playback time point by a movement time determined based on the timescale of each of the sub-paths and a distance by which each of the sub-paths moves along a preset axis.

The at least one timescale may be determined based on a distance by which a start point of each of the sub-paths is separated from a reference line.

The reference line may be a search bar of the media content playback apparatus.

The media content playback controlling method may further include displaying a main search bar for exploring a full time interval of the media content, and displaying a sub-search bar for exploring a portion of the full time interval corresponding to the timescale.

According to yet another example embodiment, there is provided a media content playback controlling method of a media content playback apparatus. The media content playback controlling method includes receiving, as an input, a drag on a display of the media content playback apparatus, and displaying a search bar for setting a playback time point of a media content based on a start point of the drag. A timescale of the search bar may be determined based on the start point of the drag.

### Advantageous Effects

According to example embodiments described herein, a media content playback apparatus and a media content playback controlling method may allow a user to precisely explore a playback time point of a media content with a least operation or manipulation.

### BRIEF DESCRIPTION OF DRAWINGS

FIG. 1 is a diagram illustrating an example of how a media content playback apparatus explores a media content in response to a gesture performed by a user according to an example embodiment.

FIG. 2 is a diagram illustrating an example of how a media content playback apparatus determines a movement time of a playback time point based on a start point of each of different drag paths according to an example embodiment.

FIG. 3 is a diagram illustrating an example of how a media content playback apparatus provides visual feedback to a user based on a start point of a drag path according to an example embodiment.

FIG. 4 is a diagram illustrating another example of how a media content playback apparatus provides visual feedback to a user based on a start point of a drag path according to an example embodiment.

FIG. 5 is a diagram illustrating examples of search bars output respectively corresponding to drag paths having different start points according to an example embodiment.

FIGS. 6A and 6B are diagrams illustrating examples of a visualized timescale or a magnification factor determined by a media content playback apparatus based on a distance between a start point of a drag path and a main search bar according to an example embodiment.

FIG. 7 is a diagram illustrating an example of how a media content playback apparatus changes a playback time point based on each of different drag paths according to an example embodiment.

FIG. 8 is a flowchart illustrating an example of a flow of operations performed by a media content playback apparatus according to an example embodiment.

FIG. 9 is a diagram illustrating an example of how a media content playback apparatus explores a media content in response to a drag performed on a search bar according to another example embodiment.

FIG. 10 is a diagram illustrating an example of how a media content playback apparatus provides visual feedback to a user in response to a drag performed by the user using a plurality of fingers according to another example embodiment.

FIG. 11 is a flowchart illustrating an example of a flow of operations performed by a media content playback apparatus according to another example embodiment.

### BEST MODE FOR CARRYING OUT THE INVENTION

Hereinafter, example embodiments will be described in detail with reference to the accompanying drawings. However, various changes, modifications, and equivalents of the methods, apparatuses, and/or systems described herein will be apparent after an understanding of the present disclosure of this application. For example, the sequences of operations described herein are merely examples, and are not limited to those set forth herein, but may be changed as will be apparent after an understanding of the present disclosure, with the exception of operations necessarily occurring in a certain order.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein, the term “and/or” includes any one and any combination of any two or more of the associated listed items.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, example embodiments will be described in detail with reference to the accompanying drawings. Regarding the reference numerals assigned to the elements in the drawings, it should be noted that the same elements will be designated by the same reference numerals, wherever possible, even though they are shown in different drawings.

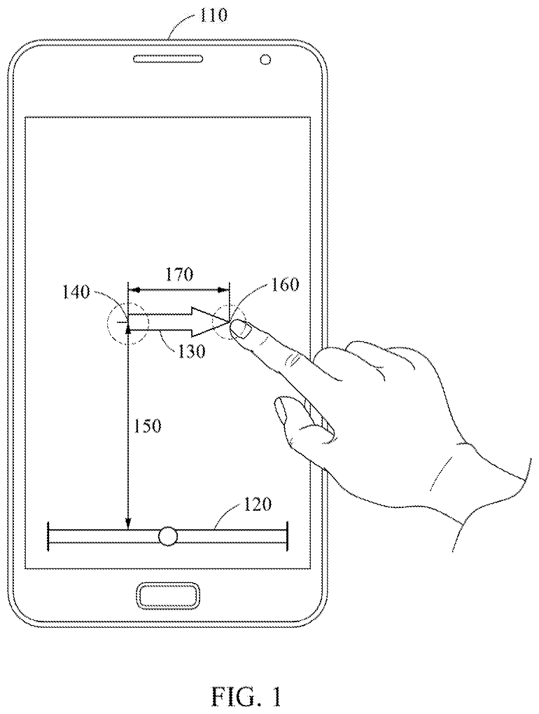

FIG. 1 is a diagram illustrating an example of how a media content playback apparatus 110 explores a media content in response to a gesture performed by a user according to an example embodiment. The user may perform a gesture, for example, a drag, to explore a media content to be played in the media content playback apparatus 110. The media content playback apparatus 110 may then change a speed at which the media content is explored in response to the gesture performed by the user.

The media content playback apparatus 110 may play the media content including video data and/or audio data. The video data and/or the audio data included in the media content may be successive or continuous data that is consistent with time. That the media content playback apparatus 110 plays the media content may indicate that the media content playback apparatus 110 continuously outputs the video data and/or audio data included in the media content as time elapses. The term “playback time point” used herein may indicate a time corresponding to a frame of the video data or audio data that is being output by the media content playback apparatus 110. In addition, the term “full playback time” may indicate a time that is used to output the entire video data and/or audio data included in the media content.

The media content playback apparatus 110 may play a media content stored in a storage device such as, for example, a hard disk, a solid-state drive (SSD), a secure digital (SD) card, a random-access memory (RAM), a read-only memory (ROM), and the like, or play a media content stored in an external storage device such as, for example, a compact disc (CD) ROM, a digital versatile disc (DVD) ROM, and the like. Further, the media content playback apparatus 110 may play a media content received through a network such as, for example, the Internet, Bluetooth, and WiFi. When the media content playback apparatus 110 receives a media content through the network, the media content playback apparatus 110 may play the media content after completing downloading the media content. In addition, the media content playback apparatus 110 may play, in real time, bitstream of the media content transmitted through streaming.

The media content playback apparatus 110 may include a display to output the video data included in the media content. The display included in the media content playback apparatus 110 may be a touchscreen including a touch sensor, for example, a capacitive touch sensor or a resistive touch sensor. In this case, the user of the media content playback apparatus 110 may intuitively control the media content to be output to the display by touching the display with a portion of a body of the user, for example, a finger of the user. In addition, the media content playback apparatus 110 may be connected to a keyboard or a mouse. In this case, the user may control the media content by moving a mouse pointer or a cursor displayed on the display using a mouse.

The media content playback apparatus 110 may include a speaker to output the audio data included in the media content. The media content playback apparatus 110 may include a port, for example, a universal serial bus (USB), to output the media content to an external display or speaker. For example, when the media content playback apparatus 110 outputs only the audio data, the display may output a visualized image of the audio data or text data corresponding to the audio data. For example, when the audio data is a song, the display may output a lyric of the song.

Referring to FIG. 1, the media content playback apparatus 110 may provide a user of the media content playback apparatus 110 with a search bar 120 that allows the user to explore a media content being played. The search bar 120 which is an interface displayed on the display may allow the user to control a playback time point of the media content. The search bar 120 may display or indicate information associated with the playback of the media content, for example, a full playback time of the media content, a playback time point of the media content, and a remaining time that is left until the playback of the media content is completed. The search bar 120 may visually indicate a relative position of the playback time point with respect to the full playback time of the media content. The media content playback apparatus 110 may display the search bar 120 on the display, and include at least one processor or controller to play the media content.

The user may perform an operation or a manipulation for exploring the media content on the display configured to display the media content. The operation for exploring the media content may be performed on the search bar 120 and performed also on a remaining area of the display excluding the search bar 120. For example, the user may perform the operation for exploring the media content by dragging a certain point of the display. In this example, the user may perform a gesture or an operation of selecting a first point on the display and then moving the selected first point to a second point on the display that is separated from the first point. This gesture or operation is referred to as a drag. For example, the user may drag the first point to the second point by touching the first point on the display and then moving a finger touching the first point to the second point while keeping touching the display. For another example, the user may drag the first point to the second point by clicking the first point on the display using a mouse and then moving a mouse pointer from the first point to the second point while keeping pressing the first point with the mouse.

Referring to FIG. 1, the user may drag the display in a direction parallel to the search bar 120 output onto the display. When the user drags the display in the direction parallel to the search bar 120, the media content playback apparatus 110 may detect a drag path 130 of the drag performed by the user as illustrated in FIG. 1. The media content playback apparatus 110 may obtain, as information associated with the drag path 130, a coordinate of a start point 140 of the drag path 130 and a coordinate of an end point 160 of the drag path 130. Further, the media content playback apparatus 110 may obtain a trajectory of the drag path 130, for example, a trajectory along which an object (e.g., a mouse pointer or a finger touching the display) dragged by the user moves between the start point 140 and the end point 160.

The media content playback apparatus 110 may identify a distance 150 between the start point 140 and the search bar 120 based on the obtained coordinate of the start point 140. The distance 150 may be a length of a vertical line that connects the start point 140 and the search bar 120. The media content playback apparatus 110 may measure a length of the drag path 130 by comparing the obtained coordinate of the start point 140 and the obtained coordinate of the end point 160. The media content playback apparatus 110 may determine the length of the drag path 130 based on a distance between the start point 140 and the end point 160. In detail, the length of the drag path 130 may be determined to be the distance between the start point 140 and the end point 160 on an axis parallel to the search bar 120. For example, the length of the drag path 130 may be determined to be a difference between an x-coordinate of the start point 140 and an x-coordinate of the end point 160 with respect to an x-axis parallel to the search bar 120. As illustrated in FIG. 1, the drag path 130 is parallel to the search bar 120, and thus the length of the drag path 130 may correspond to the difference between the x-coordinate of the start point 140 and the x-coordinate of the end point 160.

The length of the drag path 130 that is measured by the media content playback apparatus 110 may be used to adjust a playback time point of a media content. For example, the media content playback apparatus 110 may adjust the playback time point based on a distance 170 between the start point 140 and the end point 160. For example, a degree by which the media content playback apparatus 110 adjusts the playback time point based on the drag path 130, for example, a movement time of the playback time point, may be proportional to the distance 170 between the start point 140 and the end point 160. The movement time of the playback time point may be determined based on a ratio between a length of the search bar 120 and the distance 170 between the start point 140 and the end point 160.

The media content playback apparatus 110 may control the playback of the media content based on the distance 150 between the start point 140 and the search bar 120 in addition to the distance 170 between the start point 140 and the end point 160. In detail, the distance 150 between the start point 140 and the search bar 120 may be used to adjust a speed, a sensitivity, or a timescale that adjusts the playback time point based on the distance 170 between the start point 140 and the end point 160. For example, as the distance 150 increases, the speed at which the playback time point changes based on the distance 170 may decrease. That is, when the distance 150 increases, the sensitivity that the playback time point changes based on the distance 170 may decrease.

The timescale may indicate a ratio between the length of the drag path 130 and the movement time of the playback time point. The timescale may be used to determine the movement time of the playback time point. The movement time may be determined based on a combination of the length of the drag path 130 and the timescale. For example, as the distance 150 increases, the timescale may increase. In this example, when the timescale increases, the movement time may decrease. Thus, as the distance 150 increases, the user may explore the media content more precisely.

Although not illustrated, the media content playback apparatus 110 may display the search bar 120 by magnifying or enlarging the search bar 120 based on the distance 150 between the start point 140 and the search bar 120. A degree by which the search bar 120 is magnified, or a magnification factor of the search bar 120, may be determined based on the timescale that is determined based on the distance 150. The media content playback apparatus 110 may change the playback time point based on the distance 170 between the start point 140 and the end point 160, on the basis of a search bar (not shown) that is magnified based on the distance 150. Such an operation of magnifying the search bar 120 by the media content playback apparatus 110 will be described in greater detail hereinafter.

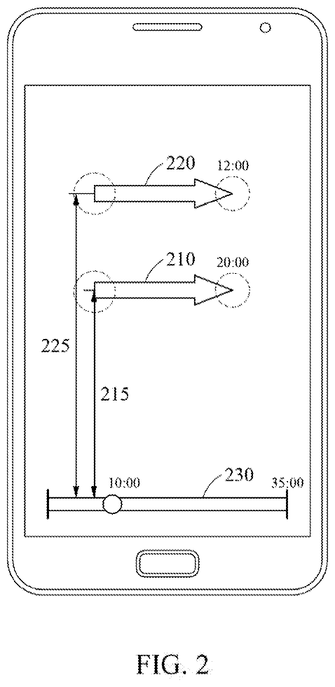

FIG. 2 is a diagram illustrating an example of how a media content playback apparatus determines a movement time of a playback time point based on a start point of each of different drag paths 210 and 220 according to an example embodiment. In the example of FIG. 2, illustrated are the different drag paths 210 and 220 of drags performed by a user on a display of the media content playback apparatus. In this example, the drag paths 210 and 220 are parallel to a search bar 230, and have a same length.

The search bar 230 may be output in a preset area of the display. The area in which the search bar 230 is output may have a rectangular shape that is parallel to one side of the display. The side of the display parallel to the area in which the search bar 230 is output may be determined based on a posture of the media content playback apparatus. That is, the area in which the search bar 230 is output may be determined based on a position or angle of the media content playback apparatus in a space. The media content playback apparatus may identify the position or angle of the media content playback apparatus in the space using a geomagnetic sensor, an acceleration sensor, or a gyro sensor. Based on the identified position or angle, the media content playback apparatus may determine the area in the display in which the search bar 230 is to be output. For example, the search bar 230 may be output to be adjacent to a side of the display that is closest to the ground. A length of the search bar 230 may be determined based on a length of the side of the display adjacent to the search bar 230, for example, the side closest to the ground.

The media content playback apparatus may determine the movement time of the playback time point to correspond to a length of each of the drag paths 210 and 220 based on a start point of each of the drag paths 210 and 220. As described above, when respective start points of the drag paths 210 and 220 are different, for example, when a distance 215 between the corresponding start point and the search bar 230 and a distance 225 between the corresponding start point and the search bar 230 are different from each other, the movement time of the playback time point may differ for each of the drag paths 210 and 220 even though the drag paths 210 and 220 have the same length. The media content playback apparatus may identify the distances 215 and 225 between the respective start points of the drag paths 210 and 220 and the search bar 230. Based on the identified distances 215 and 225, the media content playback apparatus may determine a speed, a sensitivity, a magnification factor, or a timescale that adjusts the playback time point in response to the drag paths 210 and 220.

In order to allow the user to more precisely explore a media content, the media content playback apparatus may decrease the sensitivity or the speed that adjusts the playback time point in proportion to a distance between a start point and the search bar 230. Alternatively, the media content playback apparatus may increase the magnification factor that magnifies the search bar 230, or the timescale, in proportion to the distance between the start point and the search bar 230. In the example of FIG. 2, the media content playback apparatus plays a media content with a 35-minute length and a playback time point is a 10-minute point, and it is verified that the drag path 220 is farther from the search bar 230 than the drag path 210 from the search bar 230 through a comparison between the distances 215 and 225 to the search bar 230. Thus, the media content playback apparatus may determine a relatively less value for a degree by which the media content playback apparatus adjusts the playback time point in response to the drag path 220 (for example, adjusting from 10 minutes to 12 minutes), compared to a value for a degree by which the media content playback apparatus adjusts the playback time point in response to the drag path 210 (for example, adjusting from 10 minutes to 20 minutes). In addition, the media content playback apparatus may output, to the user, the sensitivity, the speed, the magnification factor, or the timescale that is determined based on the respective start points of the drag paths 210 and 220.

On the other hand, in order to allow the user to more rapidly explore the media content, the media content playback apparatus may increase the sensitivity or the speed that adjusts the playback time point, or decrease the magnification factor or the timescale, in proportion to a distance between a start point and the search bar 230. The media content playback apparatus may display a search bar that is magnified or reduced from the search bar 230 based on the timescale, and provide the user with visual feedback.

According to an example embodiment, the drag path 210 and the drag path 220 may be included in different areas. The areas may indicate that the display is divided into a plurality of areas. To the divided areas, different magnification factors, timescales, speeds, and sensitivities may be applied. The different magnification factors, timescales, speeds, and sensitivities may be determined based on a reference line, for example, a distance from a search bar or a distance from an outer line the display.

For example, when the display is divided into two areas and the drag path 210 and the drag path 220 are included in different areas, different magnification factors, timescales, speeds, and sensitivities may be applied to the drag path 210 and the drag path 220 included in the different areas. The different magnification factors, timescales, speeds, and sensitivities to be applied may be determined based on a distance from the search bar 230, for example.

For another example, when the display is divided into two areas and the drag path 210 and the drag path 220 are included in a same area, a same magnification factor, timescale, speed, and sensitivity may be applied to the drag path 210 and the drag path 220 included in the same area. That is, although the drag path 210 and the drag path 220 have different start points, the same magnification factor, timescale, speed, and sensitivity may be applied thereto because they are included in the same area.

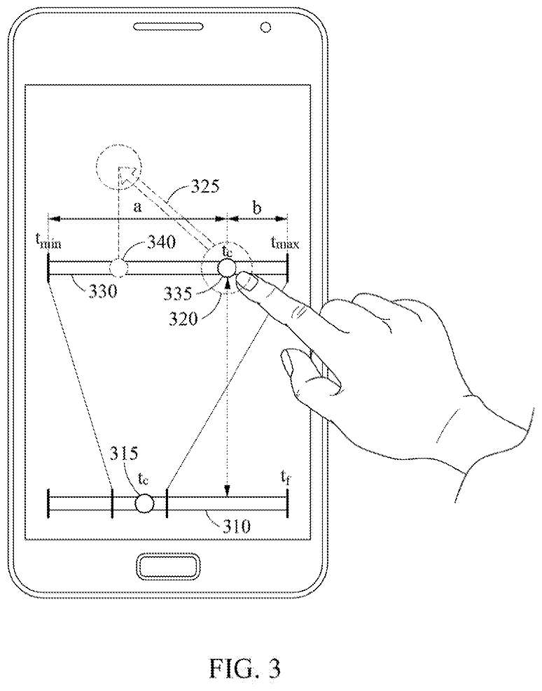

FIG. 3 is a diagram illustrating an example of how a media content playback apparatus provides visual feedback to a user based on a start point of a drag path according to an example embodiment.

Referring to FIG. 3, the media content playback apparatus may output, on a display of the media content playback apparatus, a main search bar 310 that displays time information associated with a media content that is being played. The main search bar 310 may be a search bar of which a position is not changed by a drag path of a drag performed by a user, and be a basic search bar provided by the media content playback apparatus to the user. For example, the main search bar 310 may be output in a preset area that is not changed by the drag path of the drag performed by the user. In the example of FIG. 3, the main search bar 310 is output in parallel with a bottom side of the media content playback apparatus while being adjacent to the bottom side. The main search bar 310 may have a length corresponding to the bottom side of the display. For example, the length of the main search bar 310 may be determined to be a value that is obtained by subtracting a preset margin from a length of the bottom side of the display.

The length of the main search bar 310 may match a full playback time t_{f} of the media content. Each point of the main search bar 310 may correspond to each of different portions of the media content. For example, a left end point of the main search bar 310 may correspond to a start portion of the media content, and a right end point of the main search bar 310 may correspond to a last portion of the media content, for example, the full playback time t_{f}.

As described above, the media content playback apparatus may visually indicate, in the main search bar 310, a relative position of a playback time point of the media content with respect to the full playback time of the media content. Referring to FIG. 3, the media content playback apparatus may output, in the main search bar 310, an indicator 315 that indicates a relative position of a playback time point t_{c}. A position of the indicator 315 in the main search bar 310 may be determined based on a ratio between the full playback time t_{f} and the playback time point t_{c}. For example, the length of the main search bar 310 may match the full playback time t_{f} of the media content, and thus the indicator 315 may be disposed at a position that divides the main search bar 310 at a ratio of t_{c}:t_{f}−t_{c}.

The user may drag the indicator 315 in the main search bar 310 to control a playback time point of a media content. For example, the user may drag the indicator 315 while clicking it with a mouse pointer or touching the indicator 315. Based on a ratio at which the dragged indicator 315 divides the main search bar 310, the media content playback apparatus may control the playback time point. In addition, when the user drags an outer area of the main search bar 310 in the display, for example, a remaining area excluding an area in the display in which the main search bar 310 is output, the media content playback apparatus may control the playback time point in response to a drag path of the drag performed by the user.

In the example of FIG. 3, the user drags a point 320 that is positioned outside the main search bar 310. The point 320 may be a start point of a drag path 325 of the drag performed by the user. Based on the start point of the drag path 325, the media content playback apparatus may output a sub-search bar 330 that is parallel to the main search bar 310. The sub-search bar 330 may be a search bar that is output at the start point of the drag path 325 and output corresponding to the main search bar 310. Referring to FIG. 3, the media content playback apparatus may output the sub-search bar 330 by overlapping it at the start point of the drag path 325. The main search bar 310 and the sub-search bar 330 may be in parallel with each other, and the sub-search bar 330 may be output by overlapping the point 320 which is the start point of the drag path 325, and thus a distance between the main search bar 310 and the sub-search bar 330 may correspond to a distance between the main search bar 310 and the point 320.

A length of the sub-search bar 330 may correspond to the length of the main search bar 310. Dissimilar to the fact that the length of the main search bar 310 matches the full playback time t_{f} of the media content, the length of the sub-search bar 330 may match a time interval in the full playback time t_{f} of the media content. Referring to FIG. 3, a left end point of the sub-search bar 330 may correspond to a minimum value tₘᵢₙ of the time interval, and a right end point of the sub-search bar 330 may correspond to a maximum value tₘₐₓ of the time interval. The sub-search bar 330 may correspond to the time interval in the full playback time t_{f} of the media content that includes the playback time point t_{c}. In such a case, tₘᵢₙ, t_{c}, tₘₐₓ, and t_{f} may satisfy an inequation of 0<tₘᵢₙ<t_{c}<tₘₐₓ<t_{f}. That is, the sub-search bar 330 may be a magnified search bar that magnifies a time interval of the main search bar 310 and displays the magnified time interval.

The sub-search bar 330 may visually indicate a relative position of a playback time point included in a time interval in a full playback time of a media content. Referring to FIG. 3, the media content playback apparatus may output, in the sub-search bar 330, an indicator 335 that indicates a relative position of the playback time point t_{c}. A position of the indicator 335 in the sub-search bar 330 may change corresponding to the drag path 325.

The position of the indicator 335 may move along a finger of the user or a mouse pointer that moves on the sub-search bar 330. Referring to FIG. 3, when the drag path 325 is not parallel to the sub-search bar 330, for example, when the finger of the user or the mouse pointer deviates from the sub-search bar 330, the position of the indicator 335 may change based on a movement distance of the drag path 325 in a direction or axis parallel to the sub-search bar 330. For example, the position of the indicator 335 may be determined based on a foot of perpendicular that is connected from an end point of the drag path 325 to the sub-search bar 330.

An initial position of the indicator 335 may correspond to the point 320 which is the start point of the drag path 325. The start point of the drag path 325 may correspond to a relative position of the playback time point t_{c} in the sub-search bar 330.

A time interval (tₘᵢₙ, tₘₐₓ) matching the sub-search bar 330 may be determined based on a distance between the main search bar 310 and the sub-search bar 330, or a distance between the main search bar 310 and the point 320 which is the start point of the drag path 325. According to an example embodiment, the media content playback apparatus may determine a sensitivity, a speed, a timescale, or a magnification factor of the sub-search bar 330 with respect to the main search bar 310 that adjusts a playback time point in response to a drag path, based on a distance between a start point of the drag path and the main search bar 310. A length of the time interval (tₘᵢₙ, tₘₐₓ) matching the sub-search bar 330 may be determined based on the sensitivity, the speed, the timescale, or the magnification factor.

In detail, in a search bar magnified from the main search bar 310 by the magnification factor, a length (tₘₐₓ−tₘᵢₙ) of the time interval (tₘᵢₙ, tₘₐₓ) may be determined to be a length of a time interval corresponding to the length of the sub-search bar 330. The length (tₘₐₓ−tₘᵢₙ) may be determined to be a value obtained by applying an inverse value of the magnification factor to the full playback time t_{f}. Referring to FIG. 3, the media content playback apparatus may provide the user with visual feedback on the determined sensitivity, speed, or timescale by linearly connecting, to the sub-search bar 330, a portion of the main search bar 310 corresponding to the time interval (tₘᵢₙ, tₘₐₓ) of the sub-search bar 330.

The minimum value tₘᵢₙ and the maximum value tₘₐₓ of the time interval matching the sub-search bar 330 may be determined based on a ratio at which a start point of a drag path divides the display or the sub-search bar 330. Referring to FIG. 3, when the point 320 which is the start point of the drag path 325 divides the sub-search bar 330 at a ratio of a:b, the minimum value tₘᵢₙ and the maximum value tₘₐₓ of the time interval may be determined to be values that satisfy t_{c}−tₘᵢₙ:tₘₐₓ−t_{c}=a:b because the start point of the drag path 325 corresponds to the relative position of the playback time point t_{c} in the sub-search bar 330.

Thus, when the user drags the display along the drag path 325, the media content playback apparatus may change the playback time point t_{c} within the time interval (tₘᵢₙ, tₘₐₓ) matching the sub-search bar 330. A position of the indicator 335 may change corresponding to a finger of the user or a mouse pointer that moves along the drag path 325. As illustrated in FIG. 3, the position of the indicator 335 may correspond to a foot of perpendicular that is connected from the finger of the user or the mouse pointer on the drag path 325 to the sub-search bar 330. When the indicator 335 moves along the finger of the user or the mouse pointer, the media content playback apparatus may change the playback time point t_{c} based on the ratio at which the indicator 335 divides the sub-search bar 330. When the playback time point t_{c} changes, the position of the indicator 315 in the main search bar 310 may also change, in addition to the indicator 335 in the sub-search bar 330.

As described above, the media content playback apparatus may provide the user with the sub-search bar 330 that allows the user to precisely explore a partial time interval in a full playback time t_{f} of a media content, for example, the time interval (tₘᵢₙ, tₘₐₓ) in FIG. 3, that is determined based on a distance between a start point of a drag path and the main search bar 310. The sub-search bar 330 may correspond to a portion of the main search bar 310 that is magnified based on a timescale.

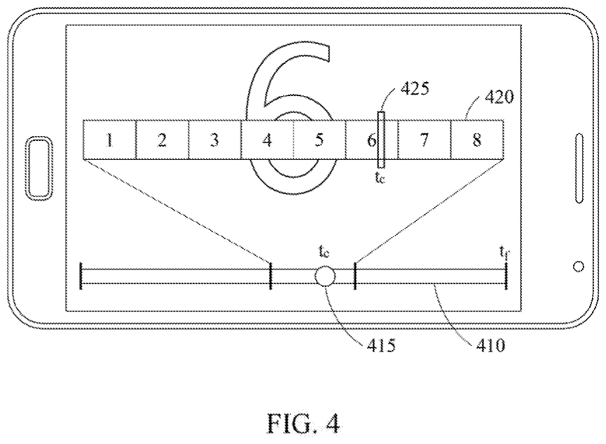

FIG. 4 is a diagram illustrating another example of how a media content playback apparatus provides visual feedback to a user based on a start point of a drag path according to an example embodiment.

Referring to FIG. 4, the media content playback apparatus may output, on a display, a frame corresponding to a playback time point t_{c} in video data included in a media content, for example, an image of the video data corresponding to the playback time point t_{c}. The media content playback apparatus may output a main search bar 410 onto the display by overlapping it to the frame to be output on the display. The media content playback apparatus may output, in the main search bar 410, a full playback time t_{f} of the media content and the playback time point t_{c} of the media content. In addition, the media content playback apparatus may output, at a position in the main search bar 410 that corresponds to a ratio between the full playback time t_{f} and the playback time point t_{c}, an indicator 415 indicating a relative position of the playback time point t_{c} with respect to the full playback time t_{f}. When the playback time point t_{c} changes, for example, when the media content playback apparatus plays the media content, the media content playback apparatus may change a position of the indicator 415 based on a changed ratio between the full playback time t_{f} and the playback time point t_{c}.

When a user drags a point on the display that is separate from the main search bar 410, the media content playback apparatus may determine a speed, sensitivity, timescale, or magnification factor that adjusts a playback time point of a media content, based on a distance between a start point of the drag performed by the user and the main search bar 410. The media content playback apparatus may output a sub-search bar 420 at the start point of the drag. The sub-search bar 420 may provide the user with a function that allows the user to explore a time interval in a full playback time of the media content. The time interval may be determined based on the determined speed, sensitivity, timescale, or magnification factor. The media content playback apparatus may output, in the sub-search bar 420, an indicator 425 indicating a relative position of a playback time point t_{c} of the time interval corresponding to the sub-search bar 420.

The media content playback apparatus may visualize video data and/or audio data of the media content that is included in the time interval corresponding to the sub-search bar 420. Referring to FIG. 4, the video data of the media content that is included in the time interval corresponding to the sub-search bar 420 may be visualized, and an image of the video data, for example, a snapshot or a thumbnail, may be output. The media content playback apparatus may output the image of the media content by overlapping the image on the sub-search bar 420. Thus, the user may more conveniently explore the media content using the image of the media content that is output on the sub-search bar 420. When the media content playback apparatus visualizes the audio data included in the time interval corresponding to the sub-search bar 420, the media content playback apparatus may output a waveform of the audio data by overlapping the waveform on the sub-search bar 420.

A form of an indicator, for example, the indicators 415 and 425, may be determined based on a form of a search bar including the indicator, for example, the indicators 415 and 425. Referring to FIG. 4, the indicator 415 that is output in a search bar having a shape of a line without visualizing a portion of a media content, for example, the main search bar 410, may have a circular or polygonal shape that overlaps a line. Alternatively, the indicator 425 that is output in a search bar having another shape in lieu of a line including an image of a media content may have another shape based on a size of a line or a size of the image of the media content, for example, a rectangular shape determined based on a height of the image.

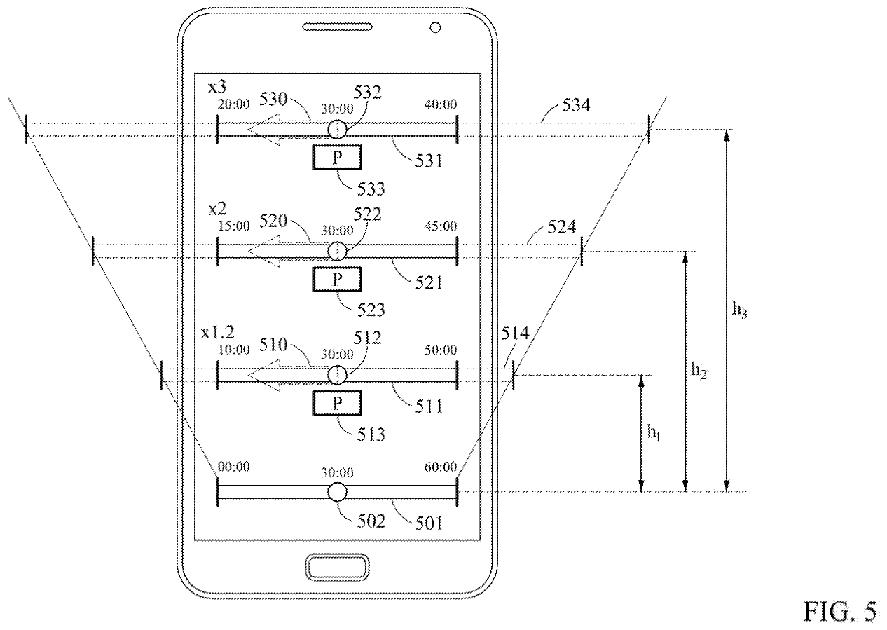

FIG. 5 is a diagram illustrating examples of search bars 511, 521, and 531 output respectively corresponding to drag paths 510, 520, and 530 having different start points according to an example embodiment. For the convenience of description, it is assumed that a content playback apparatus plays a content with a 60-minute length and a playback time point is a 30-minute point.

Referring to FIG. 5, the content playback apparatus may output a search bar 501 indicating information associated with the playback of the content. The search bar 501 may be a main search bar that is output in an area in which a gesture performed by a user does not change. According to an example embodiment, only when the user performs the gesture on the content playback apparatus, the content playback apparatus may output the search bar 501. For example, when the user touches or clicks an area in which the content is output, the content playback apparatus may output the search bar 501. When the user does not perform any action or operation during a preset amount of time after the search bar 501 is output, the content playback apparatus may hide the search bar 501.

The search bar 501 may include an indicator 502 indicating a playback time point of the content. As the content is played, a position of the indicator 502 may change based on the playback time point that changes. A length of the search bar 501 may be determined based on a length of a side of a display, and the content playback apparatus may match each portion of the content to each portion of the search bar 501. When the user drags the indicator 502, the content playback apparatus may change the position of the indicator 502 based on a drag path of the drag. Based on the changed position of the indicator 502, the content playback apparatus may change the playback time point.

In addition to such a case in which the user drags a point in the search bar 501, when the user drags a point on the display that is separated from the search bar 501, the content playback apparatus may also control a playback time point based on a drag path of the drag. Referring to FIG. 5, the content playback apparatus may receive a plurality of drags from the user, and thus receive the drag paths 510, 520, and 530 from the drags. It is assumed that respective start points of the drag paths 510, 520, and 530 are separated from the search bar 501 by h₁, h₂, and h₃, respectively.

A degree by which the content playback apparatus changes the playback time point in response to each of the drag paths 510, 520, and 530 may be determined based on a distance respectively based on h₁, h₂, and h₃, and on a distance by which each of the drag paths 510, 520, and 530 moves in a direction parallel to the search bar 501. For example, when, on an x-axis parallel to the search bar 501 and a y-axis perpendicular to the search bar 501, a coordinate of a start point of a drag path is (xᵢ, yᵢ) and a coordinate of an end point of the drag path is (x_{f}, y_{f}), the content playback apparatus may adjust a playback time point t_{c} to t_{c}′ based on Equation 1 below.

$${t}_{c}^{′} = {t}_{c} + f ( Δ x , {h}_{i} ) \{ \begin{matrix}Δ x = {x}_{f} - {x}_{i} \\ {h}_{i} = {y}_{i} - {y}_{int}\end{matrix} \qquad [ Equation 1 ]$$

In Equation 1, hᵢ denotes a difference between a y-coordinate yᵢ of a start point of a drag path and a y-coordinate yₘₜ of a reference line. The reference line may be one of a main search bar or a preset outer line of the display. For example, when the reference line is the main search bar, hᵢ denotes a difference between a y-coordinate of a start point of a drag path and a y-coordinate of the main search bar, for example, the search bar 501 in FIG. 5, or a distance between the start point of the drag path and the main search bar. Referring to FIG. 5, when the user drags the display along the drag path 510, the content playback apparatus may substitute h₁ for hᵢ in Equation 1. Similarly, the content playback apparatus may substitute h₂ and h₃ for hᵢ in Equation 1 in response to the drag paths 520 and 530, respectively.

Referring to Equation 1 above, the content playback apparatus may determine a playback time point t_{c}′ after the drag by combining, with the playback time point t_{c} before the drag, a function f(Δx, hᵢ) determined based on a parameter associated with the drag path. The function f(Δx, hᵢ) may indicate a degree of changing the playback time point t_{c}, and be determined by applying Δx to a sensitivity, speed, magnification factor, or timescale that corresponds to hᵢ. In detail, the content playback apparatus may adjust the playback time point t_{c} to t_{c}′ based on Equation 2 below.

$${t}_{c}^{′} = {t}_{c} + f ( Δ x , {h}_{i} ) = {t}_{c} + Δ x \times g ( {h}_{i} ) \times \frac{{t}_{f}}{{l}_{mt}} \qquad [ Equation 2 ]$$

In Equation 2, t_{f} denotes a full playback time of a content. lₘₜ denotes a length of a main search bar, for example, the main search bar 501 of FIG. 5. g(hᵢ) denotes a function associated with a sensitivity, speed, magnification factor, or timescale that is to be applied to Δx, and a function associated with a distance hᵢ between a start point of a drag path and the main search bar. For example, the magnification factor refers to a degree of magnifying or enlarging the main search bar corresponding to hᵢ, and thus g(hᵢ) may be determined to be an inverse value of the magnification factor. According to another example embodiment, g(hᵢ) may be a linear function, a step function, an exponential function, or a log function with respect to hᵢ.

For example, a magnification factor m(hᵢ) used to determine g(hᵢ) in Equation 2 may be determined with respect to a height h_{D} of the display in a direction perpendicular to the main search bar as represented by Equation 3 below.

$$m ( {h}_{i} ) = 1 + \frac{{h}_{i}}{{h}_{D}} ( M ) \qquad [ Equation 3 ]$$

Referring to Equation 3 above, when hᵢ=0, that is, when a start point of a drag path corresponds to the main search bar, a magnification factor may become 1. When hᵢ=h_{D}, that is, when the start point of the drag path is positioned on a side of the display on an opposite side of the main search bar, a maximum value of the magnification factor may become M+1 in which M denotes a preset constant associated with the maximum value of the magnification factor that is obtained by adjusting hᵢ. In the example of FIG. 5, M+1=3.

Referring to FIG. 5, the content playback apparatus may output the search bar 511 corresponding to the drag path 510. The search bar 511 may be a portion of a search bar 514 magnified by a magnification factor (e.g., 1.2 times) determined corresponding to hᵢ. The portion may be a portion of the search bar 514 that is to be displayed on the display. The content playback apparatus may generate the search bar 511 by translating the search bar 501 in parallel with the start point of the drag path 510 and then magnifying the search bar 501 by the magnification factor based on the start point of the drag path 510. Since the search bar 511 is generated by magnifying the search bar 501 having a length of a side of the display that matches a full playback time of a content, a time interval that is explorable using the search bar 511 displayed on the display may correspond to a portion of the full playback time of the content. The content playback apparatus may output the search bar 511 along with a magnification factor of the search bar 511.

The search bar 511 may include an indicator 512 corresponding to the playback time point. The indicator 512 may move along the drag path 510. The content playback apparatus may change the playback time point based on a positional relationship between the indicator 512 and the search bar 511 while changing a position of the indicator 512 based on the drag path 510. When the content playback apparatus changes the playback time point based on Equation 1 or 2 above, a coordinate of the indicator 512 may correspond to a coordinate (x_{f}, y_{f}) of an end point of the drag path 510.

According to an example embodiment, the content playback apparatus may output, on a preview window 513, an image of the content associated with the playback time point corresponding to the indicator 512 that changes based on the drag path 510. The content playback apparatus may move a position of the preview window 513 in parallel with the search bar 511 to correspond to a position of the indicator 512 that moves along the drag path 510.

Referring to FIG. 5, the content playback apparatus may output the search bar 521 corresponding to the drag path 520. The search bar 521 may be a portion of a search bar 524 magnified by a magnification factor (e.g., 2 times) determined corresponding to h₂ based on a start point of the drag path 520. The portion may be a portion of the search bar 524 that is to be displayed on the display. The distance h₂ between the start point of the drag path 520 and the search bar 501 is greater than the distance hi between the start point of the drag path 510 and the search bar 501, and thus the magnification factor of the search bar 521 may be determined to be a value greater than the magnification factor than the search bar 511. Thus, the user may explore the content more precisely using the search bar 521 than using the search bar 511.

The search bar 521 may include an indicator 522 corresponding to the playback time point. The content playback apparatus may change a position of the indicator 522 in the search bar 521 based on the drag path 520. The content playback apparatus may output, on a preview window 523, an image of the content associated with the playback time point corresponding to the position of the indicator 522.

Referring to FIG. 5, the content playback apparatus may output the search bar 531 corresponding to the drag path 530. The search bar 531 may be a portion of a search bar 534 magnified by a magnification factor (e.g., 3 times) determined corresponding to h₃. The portion may be a portion of the search bar 534 that is determined based on a start point of the drag path 530 and a size of an area of the display in which the search bar 531 is output. Since the distance h₃ between the start point of the drag path 530 and the search bar 501 is greater than h₁ and h₂, the magnification factor of the search bar 531 may be determined to be a value greater than the magnification factor of the search bars 511 and 521. Thus, the user may explore the content more precisely using the search bar 531 than using the search bars 511 and 521.

The search bar 531 may include an indicator 532 corresponding to the playback time point. A position of the indicator 532 may change based on a drag path of a drag performed by the user that is tracked in real time. For example, the position of the indicator 532 may change based on a movement distance of the drag path on an axis parallel to the search bar 531. The content playback apparatus may output, on a preview window 533, an image of the content associated with the playback time point corresponding to the position of the indicator 532. When the content includes video data, the content playback apparatus may output, on the preview window 533, a frame, a thumbnail, or a snapshot corresponding to the playback time point corresponding to the indicator 532. When the content includes audio data, the content playback apparatus may output, on the preview window 533, an audio waveform or text data (e.g., lyric) corresponding to the playback time point corresponding to the indicator 532.

Referring to FIG. 5, as a distance between a start point of a drag path (e.g., the drag paths 510, 520, and 530) and the search bar 501 (or a main search bar) increases, a magnification factor of a search bar (e.g., the search bars 511, 521, and 531) corresponding to the drag path (e.g., the drag paths 510, 520, and 530) may increase linearly. A magnification factor or a timescale with respect to the distance between the start point of the drag path (e.g., the drag paths 510, 520, and 530) and the search bar 501 may be determined based on an exponential function, a log function, or a step function, in addition to a linear function having a preset proportional constant.

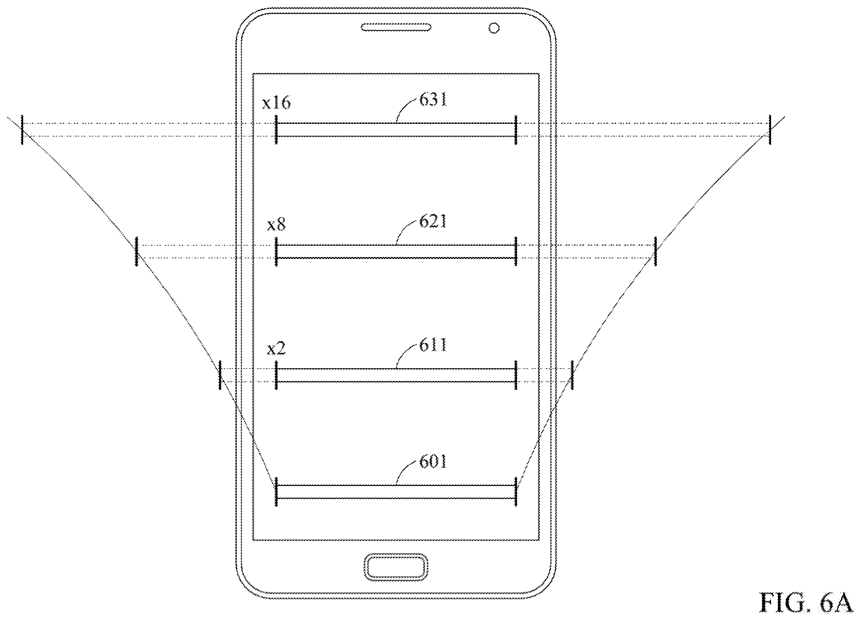

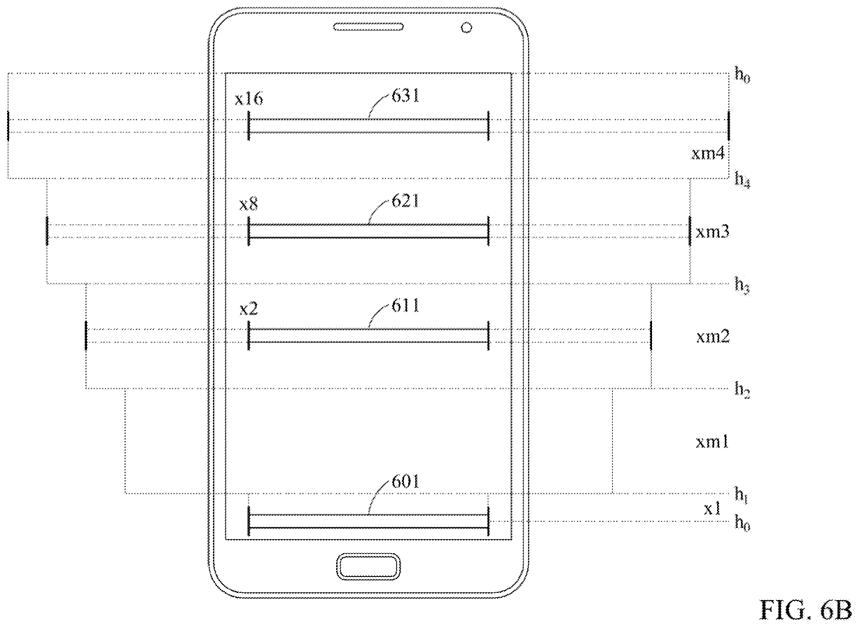

FIGS. 6A and 6B are diagrams illustrating examples of visualized timescales or magnification factors determined by a media content playback apparatus based on a distance between a start point of a drag path and a main search bar 601 according to an example embodiment.

FIG. 6A illustrates sub-search bars 611, 621, and 631 that are displayed based on respective start points of different drag paths of drags performed by a user. A magnification factor or timescale of each of the sub-search bars 611, 621, and 631 may be determined based on a non-linear function such as an exponential function and a log function. Referring to FIG. 6A, when a start point of a drag path is separated farther from the main search bar 601, a magnification factor of a corresponding sub-search bar, for example, the sub-search bars 611, 621, and 631, may increase based on the exponential function.

For example, the magnification factors of the sub-search bars 611, 621, and 631 may increase based on the exponential function with a base of 2. When a maximum value of a magnification factor, which is a magnification factor when a start point of a drag path is positioned on a side of a display on an opposite side of the main search bar 601, is 16 (2⁴=16), a magnification factor m(hᵢ) to be determined based on a distance hᵢ between the start point of the drag path and the main search bar 601 may be determined as represented by Equation 4 below.

$$m ( {h}_{i} ) = {2}^{4 \times \frac{{h}_{i}}{{h}_{D}}} \qquad [ Equation 4 ]$$

In Equation 4, h_{D} denotes a height of the display. Constants in Equation 4 may be set differently according to examples. For example, when hᵢ=0, that is, when a start point of a drag path is positioned on the main search bar 601 or extremely close thereto, the magnification factor m(hᵢ) may be 1 (m(hᵢ)=1). Referring to FIG. 6, as hᵢ gradually increases from 0, the magnification factor may increase exponentially. When hᵢ reaches the maximum value h_{D}, the magnification factor may become the maximum value which is 16.

The media content playback apparatus may use m(hᵢ) in Equation 4 to determine f(Δx, hᵢ) in Equation 1 or g(hᵢ) in Equation 2. In addition, m(hᵢ) in Equation 4 may be used to determine a speed for moving a playback time point based on the drag path, a sensitivity, or a timescale that is to be applied to the drag path.

Referring to FIG. 6B, as hᵢ increases, timescales or magnification factors may increase discretely. For example, the timescales or magnification factors of the sub-search bars 611, 621, and 631 may be determined based on the step function. When a height of the main search bar 601 on the display, for example, a y-coordinate value, is h₀, the media content playback apparatus may determine the timescales or the magnification factors to be applied to the corresponding drag paths by comparing, to a height hᵢ of a start point of a drag path, a plurality of threshold values h₁, h₂, h₃, and h₄ that are less than or equal to the height h_{D} of the display or greater than or equal to h₀. For example, the media content playback apparatus may determine a timescale or a magnification factor m(hᵢ) to be applied to a drag path as represented by Equation 5 below.

$$m ( {h}_{i} ) = \{ \begin{matrix}1 , & {h}_{0} < {h}_{i} \leq {h}_{1} \\ {m}_{1} , & {h}_{1} < {h}_{i} \leq {h}_{2} \\ {m}_{2} , & {h}_{2} < {h}_{i} \leq {h}_{3} \\ {m}_{3} , & {h}_{3} < {h}_{i} \leq {h}_{4} \\ {m}_{4} , & {h}_{4} < {h}_{i} \leq {h}_{D}\end{matrix} \qquad [ Equation 5 ]$$

The media content playback apparatus may use m(hᵢ) in Equation 5 to determine f(Δx, hᵢ) in Equation 1 and g(hᵢ) in Equation 2. In addition, m(hᵢ) in Equation 5 may be used to determine a speed for moving a playback time point based on a drag path, a sensitivity, or a timescale to be applied to the drag path.

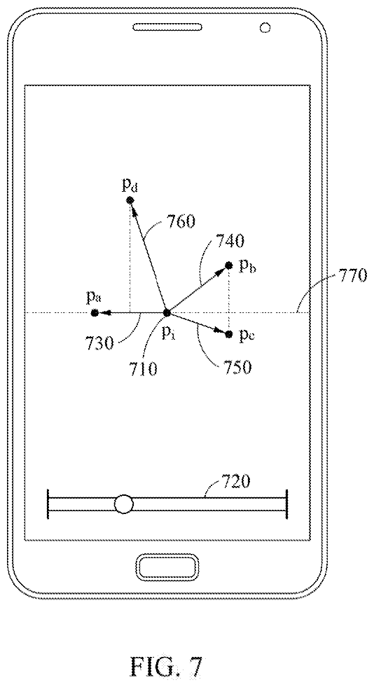

FIG. 7 is a diagram illustrating an example of how a media content playback apparatus changes a playback time point based on each of different drag paths 730, 740, 750, and 760 according to an example embodiment. In the example of FIG. 7, it is assumed that the different drag paths 730, 740, 750, and 760 have a same point pᵢ 710 as a start point, and a direction of the drag path 730 corresponds to a direction of a main search bar 720. That is, the drag path 730 is parallel to the main search bar 720.

The media content playback apparatus may change a playback time point based on the drag paths 740, 750, and 760 that are not parallel to the main search bar 720, in addition to the drag path 730 parallel to the main search bar 720. In such a case, a degree of changing the playback time point based on the drag paths 740, 750, and 760 that are not parallel to the main search bar 720 may be determined based on a distance by which the drag paths 740, 750, and 760 move on an x-axis 770 parallel to the main search bar 720. For example, respective end points of the drag paths 740 and 750 have a same x-coordinate, although respective lengths of the drag paths 740 and 750 are different as ∥p_{b}−pᵢ∥ and ∥p_{c}−pᵢ∥, and thus degrees of changing the playback time point respectively based on the drag paths 740 and 750 may be the same.

When a user drags the point pᵢ 710 in an area of the display in which the main search bar 720 is not output, the media content playback apparatus may change the playback time point and also different parameters associated with the playback of a media content. For example, when the user drags the point pᵢ 710, the media content playback apparatus may adjust brightness of the display, adjust a volume of a speaker, or output an interface (e.g., a control panel or a notification message) provided by an operating system (OS) run in the media content playback apparatus.

The media content playback apparatus may determine whether the user drags the point pᵢ 710 to change the playback time point based on a gradient of each of the drag paths 730, 740, 750, and 760. Alternatively, the media content playback apparatus may determine whether the user drags the point pᵢ 710 to change the playback time point by comparing a variation in each of the drag paths 730, 740, 750, and 760 on the x-axis 770 and a y-axis from a coordinate of a start point and an end point of each of the drag paths 730, 740, 750, and 760.

When the main search bar 720 is parallel to the x-axis 770, a gradient of a drag path is less than or equal to 45°, or an x-axis variation of a start point and an end point of the drag path is greater than a y-axis variation (e.g., as in the drag paths 730, 740, and 750 in FIG. 7), the media content playback apparatus may change a playback time point based on the drag path. For example, when the user drags the point pᵢ 710 along one of the drag paths 730, 740, and 750, the media content playback apparatus may determine that the user drags the point pᵢ 710 to change the playback time point. In this example, the media content playback apparatus may change the playback time point based on a variation of a start point and an end point of each of the drag paths 730, 740, 750 on the x-axis 770 and on a distance between the start point pᵢ 710 and the main search bar 720.

However, when a gradient of a drag path is greater than or equal to 45°, or an x-axis variation of a start point and an end point of the drag path is less than a y-axis variation (e.g., as in the drag path 760 in FIG. 7), the media content playback apparatus may not change the playback time point based on the drag path. For example, when the user drags the point pᵢ 710 based on the drag path, the media content playback apparatus may not determine that the user drags the point pᵢ 710 to change the playback time point. In this example, the media content playback apparatus may perform another operation corresponding to the drag, for example, an operation of adjusting a volume of a speaker, instead of changing the playback time point corresponding to the drag path, for example, the drag path 760.

When the user drags the point pᵢ 710 along one of the drag paths 730, 740, and 750, the media content playback apparatus may determine a degree of changing a playback time point based on the drag paths 730, 740, and 750 based on a distance between the start point pᵢ 710 and the main search bar 720. For example, the media content playback apparatus may determine a movement distance of the drag paths 730, 740, and 750 with respect to the x-axis 770 parallel to the main search bar 720, for example, Δx to be obtained from a coordinate of a start point and a coordinate of an end point, and a timescale which is a ratio of a variation in playback time point, based on the distance between the start point pᵢ 710 and the main search bar 720. The timescale may be determined based on Equations 3 through 5 described above. When the media content playback apparatus changes the playback time point based on Equation 1 or 2, the determined timescale may be used to determine f(Δx, hᵢ) or g(hᵢ). The timescale may allow a degree by which the playback time point changes when the user drags the point pᵢ 710 separate from the main search bar 720 to be different from a degree by which the playback time point changes when the user drags the main search bar 720, and thus allow the user to explore the playback time point more precisely or rapidly.

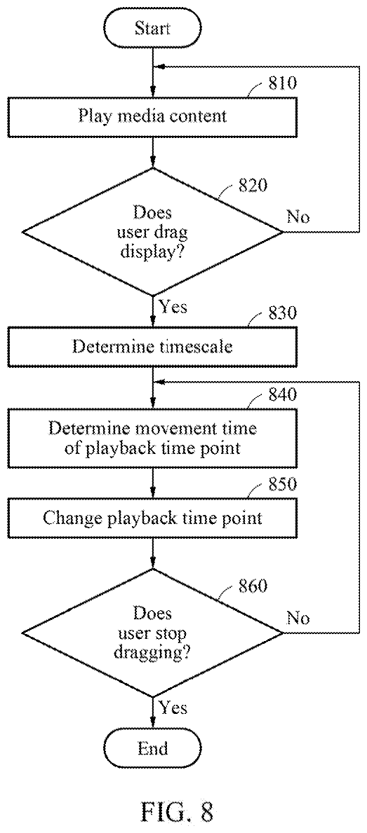

FIG. 8 is a flowchart illustrating an example of a flow of operations performed by a media content playback apparatus according to an example embodiment.

Referring to FIG. 8, in operation 810, the media content playback apparatus plays a media content. The media content playback apparatus may output video data of the media content on a display. The media content playback apparatus may output audio data of the media content through a speaker. The media content playback apparatus may play the media content based on a playback time point that changes over time.

The media content playback apparatus may output, on the display, a main search bar that allows a user to adjust the playback time point of the media content. While the media content is being played, the main search bar may be displayed in a preset area of the display. According to an example embodiment, when the user does not perform any one of a key input, a touch input, and a mouse input to the media content playback apparatus for a preset amount of time or greater, the media content playback apparatus may suspend displaying the main search bar on the display. That is, the main search bar may not be displayed when there is no input from the user.

Referring to FIG. 8, in operation 820, the media content playback apparatus determines whether the user drags the display. When the user touches the display for a preset amount of time or greater or pushes a mouse button for a preset amount of time or greater, the media content playback apparatus may determine that the user starts dragging.

When the user starts performing the drag, the media content playback apparatus may determine whether to change the playback time point of the media content. For example, the media content playback apparatus may track a position of an object dragged by the user, for example, a finger being in contact with the display, a cursor, or a mouse pointer, in advance for a preset amount of time, and obtain a path on which the object moves for the preset amount of time.

The media content playback apparatus may determine whether to change the playback time point of the media content by comparing a gradient of the obtained path to a reference value, or comparing a start point and an end point of the obtained path. For example, when a different between the gradient of the path and a gradient of an axis parallel to the main search bar (e.g., the x axis 670 illustrated in FIG. 6) is less than or equal to a preset threshold value, or when a distance by which the object moves along the axis parallel to the main search bar for a preset amount of time is greater than a distance by which the object moves along an axis perpendicular to the main search bar for the preset amount of time, the media content playback apparatus may determine to change the playback time point of the media content. That is, when the object moves in a similar direction to the axis parallel to the main search bar for a preset amount of time, the media content playback apparatus may determine to change the playback time point of the media content based on the drag.

Conversely, when the difference between the gradient of the path and the gradient of the axis parallel to the main search bar (e.g., the x axis 670 illustrated in FIG. 6) is greater than or equal to the preset threshold value, or when the distance by which the object moves along the axis parallel to the main search bar for the preset amount time is less than the distance by which the object moves along the axis perpendicular to the main search bar for the preset amount of time, the media content playback apparatus may determine not to change the playback time point of the media content.

In operation 830, when the user starts performing the drag, the media content playback apparatus determines a timescale based on a start point of the drag. The timescale may be determined based on how far the start point of the drag is separated from a reference line of the display. The reference line may be determined to be an outer line of the display or the main search bar.

The timescale may indicate a ratio between a distance by which the object moves along the axis parallel to the main search bar and a variation in the playback time point. Alternatively, the media content playback apparatus may determine a speed or sensitivity that changes the playback time point in response to a movement of the object. Alternatively, the media content playback apparatus may determine a magnification factor for magnifying the main search bar. Alternatively, the media content playback apparatus may select, from a full playback time of the media content, a time interval in which the media content is explorable in response to the drag performed by the user.

The media content playback apparatus may determine the timescale, the speed, the sensitivity, the magnification factor, or the time interval based on the distance between the start point and the main search bar. Alternatively, the media content playback apparatus may determine the timescale, the speed, the sensitivity, the magnification factor, or the time interval, based on a height of the start point, for example, a distance between a y-coordinate of the start point or a distance formed between the start point and a side of the display. For example, the media content playback apparatus may determine the magnification factor based on Equation 3 above. For another example, the media content playback apparatus may compare the distance between the start point and the main search bar to one or more intervals, and then identify a timescale corresponding to an interval including the distance.

For still another example, the media content playback apparatus may determine the speed and the sensitivity that changes the playback time point in response to a drag path of the drag, or the magnification factor or the timescale corresponding to the drag path, based on Equations 3 through 5 described above. In Equations 3 through 5, hᵢ denotes a distance between the start point of the drag and the reference line. When the start point of the drag is farther from the reference line, the speed or the sensitivity may decrease, and the magnification factor or the timescale may increase.

When the user starts performing the drag, the media content playback apparatus may display the main search bar or a sub-search bar on the display. The sub-search bar may be displayed by overlapping at the start point of the drag. The sub-search bar may correspond to a time interval in the full playback time of the media content that is determined based on the timescale and the playback time point. The media content playback apparatus may output the sub-search bar corresponding to the main search bar by overlapping it at the start point based on the determined timescale, speed, sensitivity, magnification factor, or time interval.

For example, when the identified start point is included in a remaining area excluding an area assigned to the main search bar, the media content playback apparatus may output the sub-search bar. In this example, even when the user drags a point on the display that is separated from the main search bar, the user may still explore the media content more intuitively using the output sub-search bar. The sub-search bar may be parallel to the main search bar. The media content playback apparatus may output, in the sub-search bar, the determined timescale, speed, sensitivity, magnification factor, or time interval. The media content playback apparatus may output indicators corresponding to the playback time point in the sub-search bar and the main search bar. Positions of the indicators may be determined based on relative positions of the playback time point in a time interval in each of the sub-search bar and the main search bar.

Referring to FIG. 8, in operation 840, the media content playback apparatus determines a movement time of the playback time point. The media content playback apparatus may track the path on which the user performs the drag. The path may be referred to herein as a drag path. The media content playback apparatus may track the drag path by obtaining a position of the object dragged by the user on a periodic basis. The media content playback apparatus may obtain a variation in a distance by which the object moves along an axis parallel to the main search bar or the sub-search bar by comparing positions obtained on a periodic basis.

The media content playback apparatus may change the playback time point or determine the movement time of the playback time point based on the tracked path and the determined timescale. For example, the media content playback apparatus may change the playback time point or determine the movement time based on Equation 1 or 2 described above. The media content playback apparatus may determine the movement time of the playback time point by applying the timescale determined based on the distance between the start point of the drag and the reference line to the variation in the distance by which the object moves along the axis parallel to the main search bar or the sub-search bar.

Referring to FIG. 8, in operation 850, the media content playback apparatus changes the playback time point based on the determined movement time. Based on the changed playback time point, a position of an indicator displayed in the main search bar or the sub-search bar may change. The media content playback apparatus may provide the user with an image of the media content corresponding to the changed playback time point. The image may be displayed in a preset area, for example, a preview window, that is adjacent to the sub-search bar.

Referring to FIG. 8, in operation 860, the media content playback apparatus determines whether the user stops performing the drag. When the user does not stop performing the drag, the media content playback apparatus may continue to perform an operation of determining the movement time of the playback time point based on the drag path and an operation of changing the playback time point based on the determined movement time.

However, when the user stops performing the drag, the media content playback apparatus may suspend changing the playback time point based on the tracked path. The media content playback apparatus may play the media content from the playback time point that is changed lastly. That is, until the user stops performing the drag after the user starts performing the drag, the media content playback apparatus may pause the playback of the media content and change the playback time point based on the tracked path.

As described above, the media content playback apparatus may determine whether to change a playback time point based on a movement of a finger of the user or a mouse pointer that drags the display. When changing the playback time point, the media content playback apparatus may determine a timescale which is a ratio between a movement distance by which the finger or the mouse pointer moves on an axis parallel to a main search bar and a variation in the playback time point. The media content playback apparatus may output, at a start point, a sub-search bar that is magnified or reduced based on the determined timescale.

The movement time of the playback time point may change based on a combination of the determined timescale and the movement distance of the finger or the mouse pointer on the axis parallel to the main search bar. Since a range of the movement time of the playback time point is determined based on the timescale, the user may explore a media content more precisely only using the main search bar, when exploring the media content.

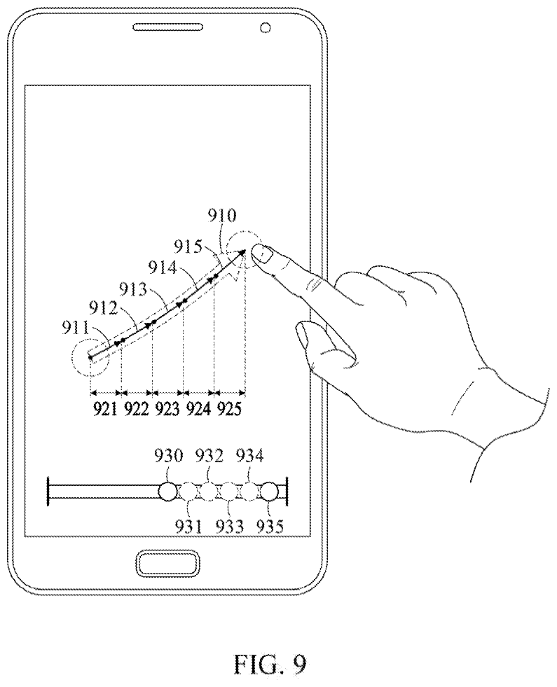

FIG. 9 is a diagram illustrating an example of how a media content playback apparatus changes a playback time point in real time while a user is performing a drag according to another example embodiment. Hereinafter, an example of how the media content playback apparatus tracks a drag path 910 of a drag performed by a user in real time, and changes a playback time point based on a result of tracking the drag path 910 in real time will be described in detail with reference to FIG. 9.

The media content playback apparatus may receive, from the user, an input that forms the drag path 910. For example, after the user starts performing the drag, the media content playback apparatus may track a coordinate of a finger of the user touching a display or a mouse pointer. In the example FIG. 9, illustrated are sub-path 1 911 through sub-path 5 915 obtained by the media content playback apparatus by tracking the finger of the user touching the display. The sub-paths 1 911 through 5 915 may be a portion of the drag path 910 that is collected while the user is performing the drag. For example, the media content playback apparatus may track the finger of the user touching the display during a preset amount of time, and obtain a sub-path from a coordinate of a start point and an end point of the finger within the amount of time.

The media content playback apparatus may determine at least one timescale based on the drag path 910. The timescale may be determined based on a position of a start point of the drag path 910, or a position of a start point of each of the sub-paths 1 911 through 5 915. For example, the media content playback apparatus may determine the timescale based on a distance between the start point of the drag path 910 and a main search bar or one side of the display. The timescale may be determined based on one of Equations 3 through 5. While the media content playback apparatus is receiving the sub-paths 1 911 through 5 915, the timescale may be maintained to be a value determined based on the start point of the drag path 910.

While the finger touching the display moves along the drag path 910, the media content playback apparatus may receive the sub-paths 1 911 through 5 915 in sequential order. Each time the media content playback apparatus receives each of the sub-paths 1 911 through 5 915 in sequential order, the media content playback apparatus may change a playback time point in response to a received sub-path. A movement time of the playback time point may be determined based on the timescale and a distance by which the received sub-path moves along a preset axis, for example, the main search bar or the one side of the display.

For example, when the media content playback apparatus receives the sub-path 1 911, the media content playback apparatus may change the playback time point based on a distance 921 by which a start point of the sub-path 1 911 moves along the main search bar. In this example, a movement time of the playback time point determined based on the sub-path 1 911 may be determined based on a timescale corresponding to the start point of the sub-path 1 911 or the start point of the drag path 910, and on the distance 921. Referring to FIG. 9, when the media content playback apparatus changes the playback time point, a position of an indicator may be moved to position 1 931 from position 0 930 which is a position before the sub-path 1 911 is received.

When the user does not stop performing the drag after sub-path 1 911 is received, the media content playback apparatus may obtain sub-path 2 912 by tracking the finger of the user touching the display. The media content playback apparatus may determine a timescale based on a start point of sub-path 2 912 or the start point of the drag path 910. The media content playback apparatus may determine a movement time of the playback time point in response to sub-path 2 912 based on the determined timescale and a distance 922 by which the start point of sub-path 2 912 moves along the main search bar. Referring to FIG. 9, when the media content playback apparatus changes the playback time point based on the determined movement time, the position of the indicator may be moved to position 2 932 from position 1 931 which is a position before sub-path 2 912 is received.

When the user does not stop performing the drag after sub-path 2 912 is received, the media content playback apparatus may change the playback time point in response to sub-paths 3 913 through 5 915 obtained in sequential order. A timescale corresponding to sub-path 3 913 may be determined based on a start point of sub-path 3 913 or the start point of the drag path 910. A movement time may be determined based on the determined timescale and a distance 923 by which the start point of sub-path 3 913 moves along the main search bar. When the media content playback apparatus changes the playback time point in response to sub-path 3 913, the position of the indicator in the main search bar may also be moved from position 2 932 to position 3 933.

A movement time corresponding to sub-path 4 914 may also be determined based on a distance 924 by which a start point of sub-path 4 914 moves along the main search bar. When the media content playback apparatus changes the playback time point in response to sub-path 4 914, the position of the indicator may also be moved from position 3 933 to position 4 934. A movement time corresponding to sub-path 5 915 may also be determined based on a combination of a distance 925 by which a start point of sub-path 5 915 moves along the main search bar and a timescale determined based on the start point of sub-path 5 915 or the start point of the drag path 910. The media content playback apparatus may change the playback time point in response to sub-path 5 915, and change the position of the indicator from position 4 934 to position 5 935.

As described above, while the media content playback apparatus is receiving the drag path 910 that is separated from the main search bar, the media content playback apparatus may change the playback time point in response to sub-paths 1 911 through 5 915 of the drag path 910. As the playback time point changes, the media content playback apparatus may change the position of the indicator in the main search bar from position 0 930 to position 5 935 in sequential order. Thus, while the user is performing the drag, the media content playback apparatus may provide the user with real-time feedback corresponding to the progression of the drag.

Further, the media content playback apparatus may provide the user with visual feedback corresponding to the drag path 910, for example, a sub-search bar that is displayed separately from the main search bar by overlapping the drag path 910.

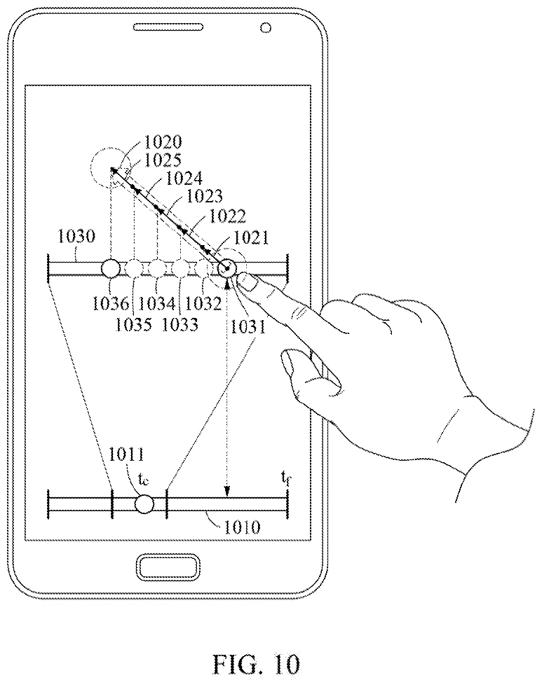

FIG. 10 is a diagram illustrating another example of how a media content playback apparatus changes a playback time point in real time while a user is performing a drag according to an example embodiment. Referring to FIG. 10, when the user starts performing the drag from a position on a display that is separated from a main search bar 1010, the media content playback apparatus may display a sub-search bar 1030 on a drag path 1020. The sub-search bar 1030 may be displayed at a start point of the drag path 1020. The sub-search bar 1030 may correspond to a time interval selected from all time intervals of a media content based on a timescale and a playback time point that are determined based on the start point of the drag path 1020. That is, the sub-search bar 1030 may be a time interval in which the user may explore the media content.

An indicator corresponding to the playback time point may be displayed at position 0 1031 in the sub-search bar 1030, which is the start point of the drag path 1020. A position of the indicator may sequentially change while the media content playback apparatus is receiving sub-paths 1 1021 through 5 1023 included in the drag path 1020. As described above with reference to FIG. 9, the media content playback apparatus may obtain sub-paths 1 1020 through 5 1023.

Since the sub-search bar 1030 corresponds to the time interval selected based on the timescale, the position of the indicator in the timescale may change based on a distance by which each of sub-paths 1 1021 through 5 1025 moves along the sub-search bar 1030. Referring to FIG. 10, the position of the indicator may move from position 0 1031 to position 1 1032 based on sub-path 1 1021. A distance by which the indicator moves, for example, a distance between position 0 1031 and position 1 1032, may correspond to the distance by which a start point of sub-path 1 1021 moves along the sub-search bar 1030. Similarly, the position of the indicator may move from position 1 1032 to position 2 1033 based on sub-path 2 1022, and thus move by a distance by which a start point sub-path 2 1022 moves along the sub-search bar 1030. Here, when the input of the drag path 1020 is stopped, the position of the indicator in the sub-search bar 1030 may be determined to be position 5 1034 in the sub-search bar 1030 corresponding to a foot of perpendicular that is connected from an end point of the drag path 1020. While the position of the indicator in the sub-search bar 1030 is changing, a position of an indicator in the main search bar 1010 may also change.

As described above, even when the user drags a remaining area excluding an area in which a main search bar is output, the media content playback apparatus may provide the user with a function of exploring a media content. When the user drags the area in which the main search bar is output, the media content playback apparatus may also provide the user with the function of exploring the media content. For example, when the user drags the area in which the main search bar is output with a plurality of fingers of the user, for example, as in a case of pinch-to-zoom, the media content playback apparatus may provide the user with a function of exploring the media content more precisely within the main search bar.

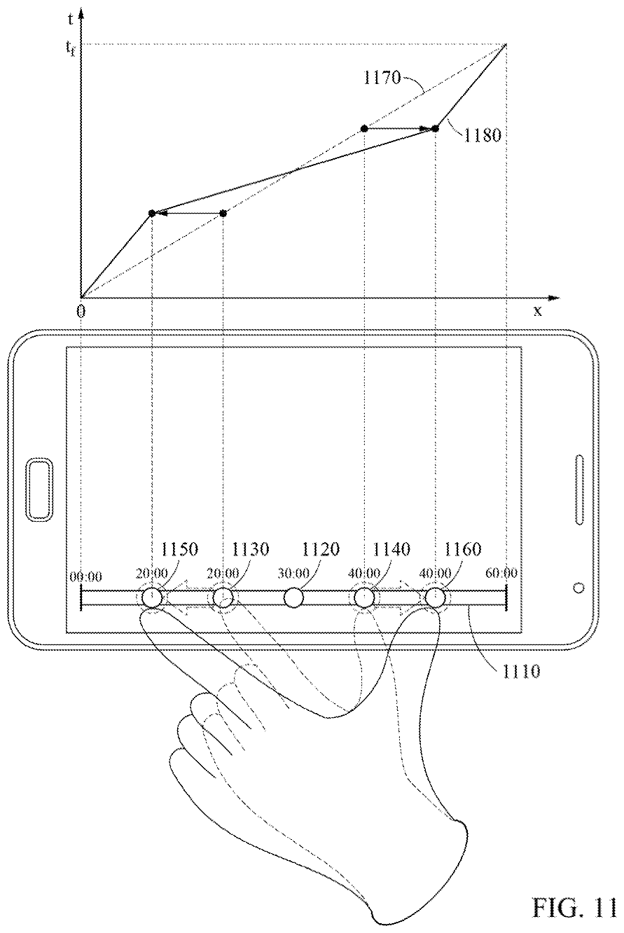

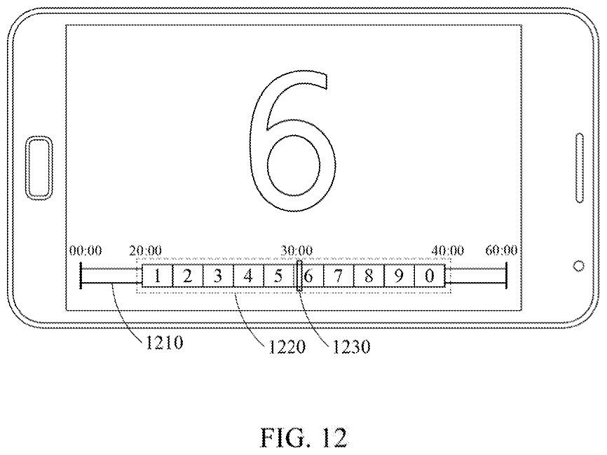

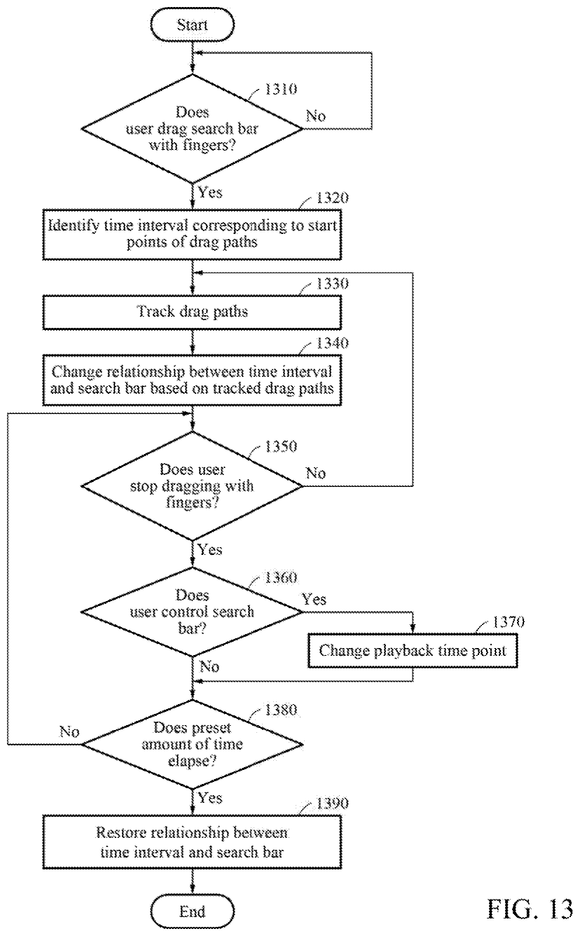

FIG. 11 is a diagram illustrating an example of how a media content playback apparatus explores a media content in response to a drag performed on a search bar 1110 according to another example embodiment. The search bar 1110 may be a main search bar that provides a user with a function of exploring the media content within a full playback time. In the example of FIG. 11, the full playback time of the media content is 60 minutes and a playback time point is a 30-minute point. The media content playback apparatus may output an indicator at a point 1120 in the search bar 1110 that corresponds to the playback time point.

When the user drags the point 1120 corresponding to the playback time point in the search bar 1110, the media content playback apparatus may change the playback time point based on a position of an end point at which the user stops performing the drag. Even when the end point is outside the search bar 110, the media content playback apparatus may change the playback time point based on the position of the end point. For example, when the user starts performing the drag by initially touching the point 1120 and then stops performing the drag at a point deviating from the search bar 1110, the media content playback apparatus may change the playback time point based on a position in the search bar 1110 that is closest to the end point at which the drag is stopped. For example, the position in the search bar 1110 may be at a foot of perpendicular that is connected from the end point. In the example of FIG. 11, illustrated is a graph indicating a relationship 1170 between an x-coordinate of the end point and the playback time point, when the search bar 1110 is parallel to an x axis. Referring to FIG. 11, a left end of the search bar 1110 may correspond to an initial portion of the media content and a right end of the search bar 1110 may correspond to a last portion of the media content. The x-coordinate of the end point and the playback time point may have the relationship 1170 of a linear function to be determined by a single proportional constant. The proportional constant may be determined based on a full playback time t_{f} and a length of the search bar 1110.

The user may touch different points in the search bar 1110, for example, points 1130 and 1140 as illustrated in FIG. 11, using a plurality of fingers of the user, and then increase or decrease a distance between the fingers touching the display. Referring to FIG. 11, the user may move a first finger touching the point 1140 on the display to a point 1160 while the user keeps touching the display with the first finger. In addition, when the user is moving the first finger, the user may move a second finger touching the point 1130 on the display to a point 1150 while the user keeps touching the display with the second finger.

The media content playback apparatus may magnify or reduce a time interval in the full playback time corresponding to the search bar 1110 based on a drag path of the first finger that moves from the point 1140 to the point 1160 and a drag path of the second finger that moves from the point 1130 to the point 1150. That is, when the user drags a portion of the search bar 1110 using a plurality of fingers of the user, the media content playback apparatus may change the relationship 1170 between each point of the search bar 1110 and the playback time point of the media content based on a dragged portion.

A maximum value and a minimum value of a time interval may be determined based on a position of each of the fingers when the user starts dragging the search bar 1110. Referring to FIG. 11, the media content playback apparatus may determine a 20-minute point and a 40-minute point respectively corresponding to the points 1130 and 1140 initially touched by the user on the search bar 1110 to be a maximum value and a minimum value of a time interval to be magnified or reduced based on a drag path.

When the user drags the search bar 1110 with the two fingers as illustrated, the media content playback apparatus may change the relationship 1170 such that a playback time point corresponding to a start point of each of respective drag paths of the fingers corresponds to an end point of each of the drag paths of the fingers. Referring to FIG. 11, a point on the search bar 1110 corresponding to the 40-minute point may be moved from the point 1140 to the point 1160 along the drag path of the first finger of the user. Similarly, a point on the search bar 1110 corresponding to the 20-minute point may be moved from the point 1130 to the point 1150 along the drag path of the second finger of the user.

In the example of FIG. 11, illustrated is a graph indicating a relationship 11110 between each point of the search bar 1110 and a playback time point of a media content after the user stops performing a drag using a plurality of fingers of the user. When the user drags a point 1120 in the search bar 1110 corresponding to the playback time point, the media content playback apparatus may change the playback time point based on a position of an end point at which the user stops dragging the point 1120 and the relationship 11110 changed in response to the drag performed using the fingers of the user. Referring to FIG. 11, the media content playback apparatus may move a point 1130 corresponding to a 20-minute point to a point 1150 and move a point 1140 corresponding to a 40-minute point to a point 1160, and thus a size of a portion of the search bar 1110 corresponding to a time interval between the 20-minute point and the 40-minute point in a full playback time of the media content may increase. Thus, the user may more precisely explore the time interval between the 20-minute point and the 40-minute point by dragging the point 1120.

FIG. 12 is a diagram illustrating an example of how a media content playback apparatus provides visual feedback to a user in response to a drag performed by the user using a plurality of fingers according to another example embodiment. According to another example embodiment, the media content playback apparatus may output, on a display, at least one frame included in a time interval that is magnified or reduced by a plurality of fingers of the user. When a media content includes only audio data, the media content playback apparatus may output, on the display, a waveform of the audio data included in the time interval magnified or reduced by the fingers.

Referring to FIG. 12, when the user magnifies a time interval between a 20-minute point and a 40-minute point, for example, when the user magnifies a point corresponding to the 20-minute point and a point corresponding to the 40-minute point using two fingers of the user, the media content playback apparatus may output frames included in a time interval determined based on respective start points of the fingers dragging the display in an area 1220 between respective end points of the fingers dragging the display.

The user may magnify the time interval in a search bar 1210 using the fingers, and then explore the media content by dragging an indicator 1230 corresponding to a playback time point. Based on the frames displayed in the area 1220, the user may more intuitively recognize a frame to be output when the user drags the indicator 1230.

FIG. 13 is a flowchart illustrating an example of a flow of operations performed by a media content playback apparatus according to another example embodiment.

Referring to FIG. 13, in operation 1310, the media content playback apparatus determines whether a user drags a search bar with a plurality of fingers. As described above with reference to FIG. 11, the user may drag a plurality of points in a main search bar that is output in a preset area using a plurality of fingers of the user. Alternatively, the user may drag a plurality of points in the sub-search bar 320 of FIG. 3 using a plurality of fingers of the user.

When a plurality of fingers of the user touches a search bar at a time interval less than or equal to a preset time interval, the media content playback apparatus may determine that the user touches the search bar with the fingers. For example, when a coordinate of one of the fingers touching the search bar changes, the media content playback apparatus may determine that a drag performed using the fingers is started.

In operation 1320, when the user drags the search bar with the fingers, the media content playback apparatus identifies a time interval corresponding to start points of respective drag paths of the fingers. For example, the media content playback apparatus may determine the time interval having, as a boundary, a playback time point corresponding to each of the start points based on a relationship between the search bar and the playback time point of the media content. The relationship between the search bar and the playback time point of the media content may be a relationship of matching each of a plurality of portions obtained by dividing the search bar and each of a plurality of playback time points of the media content. A maximum value and a minimum value of the identified time interval may respectively correspond to the fingers.

Referring to FIG. 13, in operation 1330, the media content playback apparatus tracks the drag paths. The media content playback apparatus may obtain coordinates of the fingers touching the display on a periodic basis. The media content playback apparatus may calculate a distance by which each of the fingers moves on an axis parallel to the search bar based on the obtained coordinates of the fingers.

Referring to FIG. 13, in operation 1340, the media content playback apparatus changes a relationship between the search bar and the time interval identified based on the tracked drag paths. In detail, the media content playback apparatus may change positions in the search bar respectively corresponding to the maximum value and the minimum value of the time interval identified in operation 1320. When the media content playback apparatus obtains the coordinates of the fingers touching the display on a periodic basis, the maximum value and the minimum value of the time interval identified in operation 1320 may change based on the coordinates obtained on a periodic basis. The media content playback apparatus may output, in an area in the search bar corresponding to the identified time interval, at least one image of the media content that is included in the identified time interval.

Referring to FIG. 13, in operation 1350, the media content playback apparatus determines whether the user stops performing the drag using the fingers. When the user does not stop performing the drag using the fingers, the media content playback apparatus may continue to track the respective drag paths of the fingers. However, when the user stops performing the drag using the fingers, the media content playback apparatus may determine the relationship between the time interval and the search bar based on end points of the drag paths. That is, the end points of the drag paths may respectively correspond to the maximum value and the minimum value of the time interval identified in operation 1320.

After the user stops performing the drag using the fingers, the media content playback apparatus may maintain the relationship between the time interval and the search bar that is determined based on the drag performed using the fingers for a preset amount of time. That is, even after the user detaches the fingers from the display, a result of magnifying or reducing a portion of the search bar using the fingers may be maintained for the preset amount of time. The user may touch the search bar within a preset amount of time, for example, drag an indicator corresponding to the playback time point, and change the playback time point based on the changed relationship.

Referring to FIG. 13, in operation 1360, the media content playback apparatus determines whether the user controls the search bar. That is, the media content playback apparatus may determine whether the user drags the indicator in the search bar or drags the search bar with a plurality of fingers of the user.

In operation 1370, when the user controls the search bar, for example, when the user drags the indicator that is output corresponding to the playback time point in the search bar, the media content playback apparatus changes the playback time point. The playback time point may change based on the changed relationship between the time interval and the search bar. Thus, the media content playback apparatus may change the playback time point based on a result of magnifying or reducing a portion of the search bar by the user using the fingers.

In operation 1380, when the user stops performing the drag using the fingers and does not control the search bar, the media content playback apparatus may determine whether a preset amount of time elapses. That is, the media content playback apparatus may determine whether an amount of time for maintaining the relationship between the time interval and the search bar that is determined in response to the drag performed using the fingers elapses or not.

In operation 1390, when the preset amount of time elapses, the media content playback apparatus restores the changed relationship between the time interval and the search bar to the relationship which is before the drag is performed using the fingers.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A media content playback controlling method of a media content playback apparatus, comprising:
receiving, as an input, a drag on a display of the media content playback apparatus; and
moving a playback time point of a media content by a movement time corresponding to a length of the drag,
wherein the movement time is determined based on a timescale determined by a start point of the drag.

2. The media content playback controlling method of claim 1, wherein the timescale determined by the start point of the drag is maintained during progression of a path of the drag.

3. The media content playback controlling method of claim 2, wherein the timescale is determined by a distance by which the start point of the drag is separated from a reference line of the display.

4. The media content playback controlling method of claim 3, wherein the reference line is a main search bar displayed on the display or an outer line of the display.

5. The media content playback controlling method of claim 1, further comprising:
displaying, on the display, a sub-search bar based on the timescale.

6. The media content playback controlling method of claim 5, further comprising:
displaying a main search bar for exploring a full time interval of the media content,
wherein the sub-search bar corresponds to a portion of the full time interval corresponding to the timescale.

7. The media content playback controlling method of claim 6, further comprising:
displaying an image of a plurality of playback time points included in the portion of the full time interval, among images included in the media content, in response to the sub-search bar.

8. The media content playback controlling method of claim 1, further comprising:
displaying, on the display, information associated with the determined timescale.

9. The media content playback controlling method of claim 1, wherein the length of the drag is a distance by which a path of the drag moves along a preset axis on the display.

10. A non-transitory computer-readable storage medium storing instructions that are executable by a processor to perform the media content playback controlling method of claim 1.

11. A media content playback apparatus configured to play a media content, comprising:
a controller configured to control playback of the media content; and
a display configured to display a playback screen corresponding to a playback time point of the media content,
wherein the controller is configured to move the playback time point of the media content by a movement time corresponding to a length of a drag input on the display based on a timescale corresponding to a start point of the drag.

12. The media content playback apparatus of claim 11, wherein the timescale determined by the start point of the drag is maintained during progression of a path of the drag.

13. The media content playback apparatus of claim 12, wherein the controller is configured to determine the timescale based on a distance by which the start point of the drag is separated from a reference line of the display.

14. The media content playback apparatus of claim 13, wherein the reference line is a main search bar displayed on the display or an outer line of the display.

15. The media content playback apparatus of claim 11, wherein the display is configured to display a sub-search bar based on the timescale.

16. The media content playback apparatus of claim 15, wherein the display is configured to display a main search bar for exploring a full time interval of the media content,
wherein the sub-search bar is configured to display a portion of the full time interval corresponding to the timescale.

17. The media content playback apparatus of claim 16, wherein the display is configured to display an image of a plurality of playback time points included in the portion of the full time interval among images included in the media content, in response to the sub-search bar.

18. The media content playback apparatus of claim 11, wherein the display is configured to display information associated with the timescale.

19. The media content playback apparatus of claim 11, wherein the length of the drag is a distance by which a path of the drag moves along a preset axis on the display.

20. A media content playback controlling method of a media content playback apparatus, comprising:
receiving, from a user, an input that forms a drag path;
determining at least one timescale based on the drag path; and
moving a playback time point of a media content based on the timescale and the drag path,
wherein one of the at least one timescale is determined based on a start point of the drag path.

21. The media content playback controlling method of claim 20, wherein the at least one timescale is determined respectively for a plurality of sub-paths forming the drag path based on a start point of each of the sub-paths.

22. The media content playback controlling method of claim 21, wherein the moving comprises:
moving the playback time point by a movement time determined based on the timescale of each of the sub-paths and a distance by which each of the sub-paths moves along a preset axis.

23. The media content playback controlling method of claim 21, wherein the at least one timescale is determined based on a distance by which a start point of each of the sub-paths is separated from a reference line.

24. The media content playback controlling method of claim 23, wherein the reference line is a search bar of the media content playback apparatus.

25. The media content playback controlling method of claim 20, further comprising:
displaying a main search bar for exploring a full time interval of the media content; and
displaying a sub-search bar for exploring a portion of the full time interval corresponding to the timescale.

26. A media content playback controlling method of a media content playback apparatus, comprising:
receiving, as an input, a drag on a display of the media content playback apparatus; and
displaying a search bar for setting a playback time point of a media content based on a start point of the drag,
wherein a timescale of the search bar is determined based on the start point of the drag.
